(19) United States
(12) Patent Application Publication
(10) Pub. No.: US 2003/0137898 A1
(43) Pub. Date: Jul. 24, 2003

(54) Mixer

(76) Inventors: Ingo Wagner, Steinebach (DE); Gerd Brandhorst, Landsberg (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/258,125

(22) PCT Filed: Apr. 11, 2001
(86) PCT No.: PCT/EP01/04141

(30) Foreign Application Priority Data
Apr. 20, 2000 (DE) 10019893.7

(51) Int. Cl. B01F 7/04

(52) U.S. Cl. 366/172.1; 222/145.6

(57) ABSTRACT

The invention relates to a device that is used for mixing pasty materials, wherein the elasticity module of the device is greater than 200 N/mm² and/or strain at break of the material of the device ranges from 2 to 1000%, and wherein the device has at least two non-circular openings.

The invention relates to a device in the form of a mixer, in particular a dynamic mixer, and/or in the form of a cartridge front, which is used for mixing highly viscous pastes, and to a combination of the two devices.

A two-component dispensing device is described in EP 0 232 733 A or U.S. Pat. No. 5,487,606. Such dispensing devices are also referred to as static or flow mixers.

These mixers are essentially suitable only for mixing up relatively small amounts of readily mixable materials of not all that high viscosity. The mixer is fitted onto a double cartridge, in which there are two plungers. The force transmission to the plungers takes place manually. The quality of the mixing result is ultimately dependent on the length of the mixing cannula and the number of helices contained in it. Since the volume of the mixing cannula is not negligible in relation to the volume of the cartridge, an undesired loss of material which is to be mixed or has been mixed occurs when the mixing cannula is changed.

Some of these problems can be obviated by using a dynamic mixer such as that described in WO 98/43727.

A method and a device for mixing at least two pasty materials is also described in DE 42 02 591 A1. The device comprises two containers, the outlet stubs of which are arranged in parallel next to each other for being jointly coupled onto a mixer.

An essentially ideal mixer on the one hand allows a high material throughput with consistent mixing quality, and on the other hand it has a small overall size, to avoid material being lost during mixing and to keep the production costs down.

A typical dynamic mixer has two round inlet orifices for the materials to be mixed, and also an orifice for receiving a drive shaft, which drives the mixing blades. The materials to be mixed are usually delivered from corresponding cartridges by means of electrically driven plungers.

A high throughput with consistent mixing quality is desired.

However, the amount of mixable material per unit of time is restricted on the one hand by the size of the inlet orifices, and on the other hand by the force which can be transmitted to the plungers.

Enlargement of the diameter of the round inlet orifices inevitably leads to an enlargement of the mixer as a whole and consequently also to undesired enlargement of the dead volume.

Changing the geometry of the inlet orifices leads to problems with regard to the sealing at this point and is also restricted by the necessary orifice for the drive shaft.

Alternatively, the force on the rams could be increased. However, this measure is limited by the material properties of the device in conjunction with the size of the inlet orifices.

Consequently, it is an object of the present invention to provide a device for mixing which permits a higher material throughput with essentially the same mixing quality and preferably the same ram pressure which has to be applied by the mixing device to transport the materials.

This object is achieved by a device as described in the claims.

By making the inlet orifices a shape other than circular, it is possible to provide larger inlet orifices for the materials to be mixed while the overall size of the mixer or the cartridge front remains the same.

While maintaining the parameters mentioned, which are characteristic of the material of the mixer or the cartridge front, it may also be possible to dispense with the provision of additional seals, such as sealing lips and/or sealing rings.

In this case, the device in the form of a mixer or a cartridge front is on the one hand adequately elastic and flexible to act as its own seal, and on the other hand adequately stable to be able to handle the forces occurring during the delivery of the material to be mixed or during mixing.

A material which has a modulus of elasticity measured in accordance with DIN 53455 of greater than 200 N/mm², preferably in the range from 200 to 3600 N/mm², particularly preferred in the range from 500 to 1500 N/mm², has proven to be advantageous.

A material which has an elongation at break [%], likewise measured in accordance with DIN 53455, in the range from 2 to 1000, preferably in the range from 100 to 800, has also proven to be favorable.

The material is preferably of such a nature that it has a modulus of elasticity and elongation at break as described above in combination.

Materials which do not have at least one of the aforementioned properties have proven to be unsuitable for mixers, in particular dynamic mixers, and/or cartridge fronts with orifices which are of a shape other than circular.

For the purposes of the present invention, the term orifice is to be understood as meaning both inlet orifices and outlet orifices. This is dependent on in which direction the substances to be mixed are flowing or are forced and dependent on whether orifices in the mixer or the cartridge front are being considered.

A cartridge front usually has at least one inlet orifice, which corresponds to the at least one outlet orifice.

On the other hand, a mixer usually has two inlet orifices and only one outlet orifice.

Oval orifices and/or orifices of a kidney or sickle shape, in particular orifices with rounded-off edges and corners, are advantageous.

A design of this type permits an optimized arrangement of the inlet orifices around the orifice for the drive shaft, usually located at the center of a dynamic mixer. Furthermore, this design allows virtually the entire surface area of a dynamic mixer that is available for the inlet orifices to be utilized.

The device according to the invention preferably has at least two, but possibly also three or four orifices.

The orifice of a shape other than circular usually has a surface area which is larger than would be possible in the case of a circular configuration.

These orifices are usually arranged symmetrically around the orifice for the drive shaft.

The drive of the mixing element may, however, also take place off-center, as described for example in PCT/EP 00/09447.

The device according to the invention in the form of a dynamic mixer usually comprises at least three components, in particular a base plate (1), in which the non-circular inlet orifices (2, 3) and the orifice (4) for the drive shaft (not shown) are made, and a rotor (5), which is rotatably mounted in the base plate (1) and to which the mixing blades (6) are attached and a shaped groove (7) for receiving the drive shaft, and also the housing (8) in which the rotor (5) runs.

If appropriate, the device additionally has at least one seal in the region of the inlet orifices (2, 3).

The groove (7) for the drive shaft may be of any desired shape, provided that a force transmission adequate for mixing can take place from the drive shaft to the mixing blades (6).

Orifices of an angular shape have proven to be favorable for the transmission of the torque from the drive shaft to the rotor. The shaped groove (7) for the drive shaft is preferably triangular, rectangular, square, pentagonal, hexagonal, heptagonal, octagonal or formed as a hollow pinion.

The length and/or diameter of the mixer usually lie in the range from 5 to 1000 mm, preferably in the range from 10 to 100 mm.

The surface area of the inlet orifices usually lies in the range from 0.1 to 5000 mm², preferably in the range from 1 to 400 mm².

To ensure homogeneous thorough mixing of the substances to be mixed without soiling the device in the region of its outer surface, it is necessary for the mixer and the cartridge front that is to be pushed into the mixer to be made to match each other.

This matching is usually achieved by adapting the geometries of the orifices of the cartridge front (10, 11) to the inlet orifices (2, 3) of the mixer. This can be achieved by plug-in, snap-in or possibly also screwed connections.

Alternatively or additionally, the matching may also take place by adapting the materials.

It has been found that good sealing effects can be attained in particular if the material of the mixer has a modulus of elasticity in the range from 800 to 1400 N/mm² and/or an elongation at break in the range from 200 to 800% and the material of the cartridge front has a modulus of elasticity in the range from 2000 to 3000 N/mm² and/or an elongation at break in the range from 50 to 200%.

A comparably good sealing effect can be achieved if the material of the mixer has a modulus of elasticity in the range from 2000 to 3000 N/mm² and/or an elongation at break in the range from 50 to 200% and the material of the cartridge front has a modulus of elasticity in the range from 800 to 1400 N/mm² and/or an elongation at break in the range from 200 to 800%.

Suitable materials for the device, in particular in the form of a mixer and/or a cartridge front with two non-circular inlet or outlet orifices are PE, OPP, PP, PTFE, PC and/or POM. The materials are preferably used in a fiber-reinforced and/or filled form.

Suitable fibers and fillers are glass fibers/particles and carbon fibers/particles.

Suitable mixers and/or cartridge fronts can be produced, for example, by the injection-molding process, if appropriate in a 2-component injection-molding process.

The mixers and cartridge fronts according to the invention can be used in all areas of technology, in particular for mixing highly viscous, pasty and/or thick-flowing materials.

These are generally to be understood as meaning substances which, in the stored state, have to be kept in at least two components and mixed before use.

The following are mentioned by way of example: adhesives, joint sealants, paints.

The mixers and cartridge fronts according to the invention can preferably be used in the dental sector. In particular, the devices according to the invention are suitable for mixing highly viscous impression materials, which are forced by means of electrically driven rams out of film bags which have been pushed into suitable cartridges. It is also conceivable and possible for the materials to be delivered from suitable cartridges which are filled directly with the material without a film bag being used.

The term highly viscous materials covers all materials with a viscosity determined by consistency testing in accordance with DIN 4823 class 0 to 3, which are measured with a diameter of less than 80 mm.

Silicones, polyethers, polyether silicones, epoxies and polyurethanes are mentioned by way of example as materials.

Preferred exemplary embodiments are explained below on the basis of the drawings.

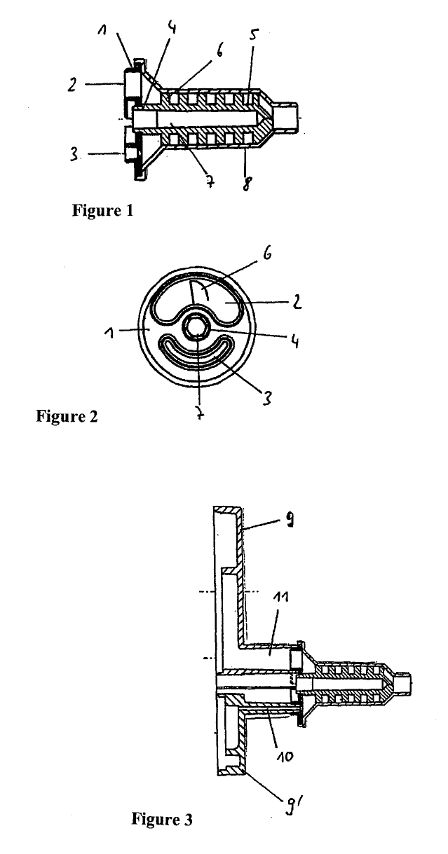

FIG. 1 shows the device in the form of a dynamic mixer in longitudinal section.

FIG. 2 shows the device in the form of a dynamic mixer in plan view.

FIG. 3 shows the device, comprising a mixer and a cartridge front.

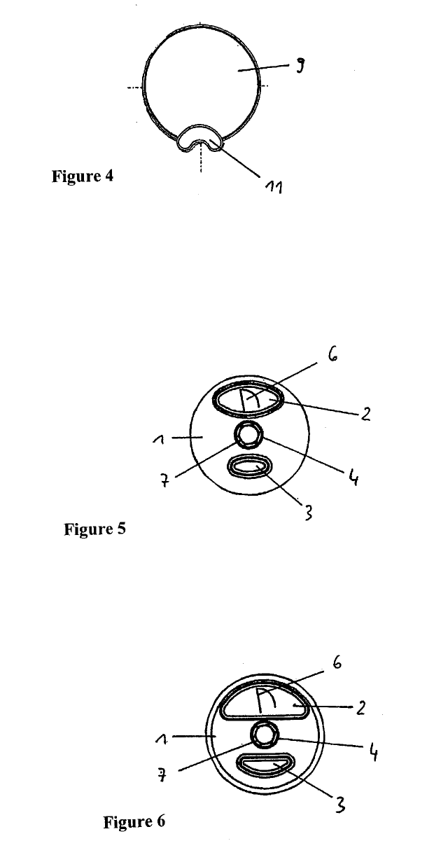

FIG. 4 shows the configuration in the form of a cartridge front in plan view.

FIGS. 5 and 6 show further embodiments of a dynamic mixer in plan view.

FIG. 1 shows the device according to the invention in the form of a dynamic mixer with the three components, base plate (1), into which the non-circular inlet orifices (2, 3) and the orifice (4) for the drive shaft have been made, a rotor (5), which is rotatably mounted in the base plate (1) and to which the mixing blades (6) are attached, the orifice having a shaped groove (7) for receiving the drive shaft, and also the housing (9) in which the rotor (5) runs.

FIG. 2 shows the device according to the invention in the form of a dynamic mixer with two kidney-shaped inlet orifices of different sizes (2, 3) and a round orifice (4) with a hexagonal shaped groove (7) for the drive shaft. Also indicated is the mixing blade (6), to be seen here in orifice (2).

FIG. 3 shows the device according to the invention, comprising the mixer according to FIG. 1 in conjunction with two cartridge fronts (9, 9,′). The two inlet orifices (2, 3) of different sizes of the dynamic mixer correspond to the two outlet orifices (10, 11) of the cartridge front.

FIG. 4 shows a cartridge front in plan view with a kidney-shaped orifice (10), which corresponds for example to the orifice (3) in FIG. 2.

Further design possibilities for the non-circular orifices of the device according to the invention in the form of a dynamic mixer can be seen in FIGS. 5 and 6.

The mixer in FIG. 5 has two orifices of an oval shape, the mixer in FIG. 6 has two orifices of a semicircular shape with rounded-off comers.

List of Designations

base plate (1)

inlet orifices (2, 3)

orifice for drive shaft (4)

rotor (5)

mixing blade (6)

shaped groove (7)

housing (8)

cartridge front (9, 9′)

orifices of the cartridge front (10, 11)

1. A device in the form of a dynamic mixer or a cartridge front which is used for mixing pasty materials, with at least two orifices, at least one of which is non-circular, the device in the form of a mixer being designed for connection to at least one device in the form of a cartridge front, which has corresponding orifices,
and either the modulus of elasticity of the material of the device in the form of a mixer having a modulus of elasticity in the range from 800 to 1400 N/mm² and/or an elongation at break in the range from 200 to 800%, and the elongation at break of the material of the device in the form of a cartridge front lying in the range from 50 to 200% and/or the modulus of elasticity lying in the range from 2000 to 3000 N/mm²,
or the modulus of elasticity of the material of the device in the form of a cartridge front having a modulus of elasticity in the range from 800 to 1400 N/mm² and/or an elongation at break in the range from 200 to 800%, and the elongation at break of the material of the device in the form of a mixer lying in the range from 50 to 200% and/or the modulus of elasticity lying in the range from 2000 to 3000 N/mm².

2. The device as claimed in claim 1 in the form of a mixer with two, three or four non-circular orifices.

3. The device as claimed in one of the preceding claims, the at least one non-circular orifice being kidney-shaped, oval or sickle-shaped.

4. The device as claimed in one of the preceding claims in the form of a dynamic mixer, a shaped groove which is triangular, rectangular, pentagonal, hexagonal, heptagonal, octagonal, star-shaped or formed as a hollow pinion being located in the orifice for the drive shaft.

5. A method for producing a device as claimed in one of the preceding claims by injection-molding.

6. The use of a device as claimed in one of the preceding claims for mixing highly viscous, pasty and/or thick-flowing materials.

7. The use of a material with a modulus of elasticity in the range of greater than 200 N/mm² and/or an elongation at break in the range from 2 to 1000% for producing a device in the form of a dynamic mixer or a cartridge front, with a least two orifices, one of which is non-circular, the device in the form of a mixer being designed for connection to at least one device in the form of a cartridge front, which has corresponding orifices.
